(19) United States
(12) Patent Application Publication
(10) Pub. No.: US 2018/0141816 A1
(43) Pub. Date: May 24, 2018

(54) HIGH-EFFICIENCY METHOD AND DEVICE FOR HIGH-CONCENTRATION, LOW-TEMPERATURE EXOGENOUS NITRIC OXIDE PRODUCTION FROM ATMOSPHERIC AIR

(71) Applicant: Origin, Inc., Princeton, NJ (US)

(72) Inventors: Andre' DiMino, Woodcliff Lake, NJ (US); Matt Drummer, Fort Lee, NJ (US); Lindley Curameng, Fort Lee, NJ (US); Dave Meck, Bloomfield, NJ (US); Elizabeth S. Hanna, Princeton, NJ (US)

(73) Assignee: Origin, Inc., Princeton, NJ (US)

(21) Appl. No.: 15/815,844

(22) Filed: Nov. 17, 2017

Related U.S. Application Data
(60) Provisional application No. 62/423,957, filed on Nov. 18, 2016.

(51) Int. Cl. C01B 21/20; C01B 21/32; B01J 19/08

(52) U.S. Cl. CPC C01B 21/203; B01J 19/088; C01B 21/32

(57) ABSTRACT

An apparatus for treating a biologic object includes a device for forming NO-containing gas flow to treat the biologic object and a plasma cooling mechanism coupled to a distal end of the device. The plasma cooling mechanism may include a cooling member and/or a cooling apparatus. The cooling member is coupled to a distal end of the device and includes a fluid conduit and a cooling chamber surrounding the fluid conduit. The cooling apparatus is coupled to a distal end of the cooling member so that the NO-containing gas flow travels from a discharge aperture formed in the device through the fluid conduit and passed the cooling apparatus before reaching the biologic object.

### CROSS-REFERENCE TO RELATED APPLICATIONS

This is a non-provisional of co-pending U.S. provisional patent application Ser. No. 62/423,957, filed Nov. 18, 2016, titled “High-Efficiency Method and Device for High-Concentration, Low-Temperature Exogenous Nitric Oxide Production From Atmospheric Air,” the entirety of which application is incorporated by reference herein.

### FIELD OF THE DISCLOSURE

The present disclosure generally relates to medical equipment and more specifically to devices and methods for providing treatment of a biological object with mixed gases containing nitric oxide. The disclosed methods and devices may be suitable for treating various pathological processes in general, including abdominal, thoracic, purulent, vascular and anaplastic surgery, oncology, urology, combustiology, dentistry, podiatry, ophthalmology, neurosurgery and other fields of medicine.

### BACKGROUND OF THE DISCLOSURE

U.S. Pat. No. 7,498,000, the entire contents of which are incorporated by reference, discloses an apparatus and method for forming a nitric oxide (NO)-containing gas flow to treat a biologic object. Referring to FIG. 1, the apparatus may include a housing 1, an anode 2, and a cathode 3 located inside of the housing 1. The anode and cathode 2, 3 are arranged so that an interelectrode area 5 may be provided between the anode and cathode 2, 3 to generate a direct current arc discharge. The anode and cathode 2, 3 may be electrically insulated from each other. In use, an arc discharge may be generated between the anode and cathode 2, 3 by providing an open-circuit dc voltage across the anode and cathode 2, 3 and generating at least one high-voltage pulse to generate a spark discharge between the anode and cathode 2, 3. A positive potential may be applied to one of the electrodes being an anode while a negative potential may be applied to the other electrode being a cathode.

The apparatus may also include an arc discharge stabilization electrode or floating potential electrode 15 disposed in the interelectrode area 5. The floating potential electrode 15 may be electrically insulated from the anode and the cathode. The floating potential electrode 15 may include a through hole 16 coaxial with the cathode to provide a steady discharge burning. Further, the apparatus may include an inlet channel and an outlet channel 4. The inlet channel may be in communication with the interelectrode area 5 for injecting source gas or atmospheric air into the interelectrode area 5. The source gas containing at least oxygen and nitrogen. The outlet channel 4 is used for withdrawing NO-containing gas flow from the interelectrode area 5 and directing said NO-containing gas flow to treat the biologic object. The NO-containing gas flow may be formed from the source gas under the effect of the direct current arc discharge. Cooling means for cooling the outlet channel 4 and at least one of said anode and cathode may also be provided.

One limitation of the apparatus and method disclosed in U.S. Pat. No. 7,498,000 for a number of human and animal therapeutic applications is that the relatively high temperature generated by the arc discharge prevents its usage in medical and veterinary applications where elevated temperatures would be contraindicated. For example, it has been determined that the temperature of the NO-containing gas (also referred to as a plasma plume) may be between approximately 100 to 300 degrees Celsius. The relatively high temperature of the NO-containing gas prevents the device and method from being used in a variety of applications including, but not limited to, ophthalmic therapeutics due to direct tissue damage as well as the possibility of heat induced cataracts; intra-oral applications where mucous membrane tissue can be adversely affected; and, a number of other such applications.

The relatively high temperatures associated with the NO-containing gas output also requires that the device be maintained at a certain minimum distance from any treatment area to avoid pain from the relatively high heat and possible burns to the treatment area or other deleterious effects. However, the increased distance from the treatment area means that a lower concentration of NO is directed onto the treatment area due to, for example, air dissipation, thereby reducing the efficacy from that which can be achieved when using higher NO concentrations. In addition, the exposed arc discharge plasma plume does not allow for an efficient conversion of the nitrogen and oxygen molecules in atmospheric air into NO molecules due to, for example, dissipation surrounding the exit aperture of the device described in U.S. Pat. No. 7,498,000. That is, the increased distance causes the concentration of the NO produced to drop due to dissipation, thereby reducing the effectiveness of the treatment with higher NO levels.

In view of the foregoing, it would be desirable to provide an improved device and method that overcomes the deficiencies and limitations associated with the prior art device.

### SUMMARY OF THE DISCLOSURE

An apparatus for treating a biologic object is disclosed. The apparatus can include a device for forming NO-containing gas flow to treat the biologic object, the device including a distal end having a discharge aperture for releasing NO-containing gas flow. The apparatus can include a cooling member having a first end, a second end, a fluid conduit extending from the first end to the second end, and a cooling chamber located between the first and second ends and surrounding the fluid conduit. The first end of the cooling member can be coupled to the distal end of the device. The apparatus can further include a cooling apparatus coupled to the distal end of the cooling member. The fluid conduit may be in fluid communication with the discharge aperture so that the NO-containing gas flow travels from the discharge aperture through the fluid conduit and past the cooling apparatus before treating the biologic object.

In some embodiments, the first end of the cooling member is removably attached to the distal end of the device. The first end of the cooling member may include a plurality of threads for engaging a plurality of threads formed on the distal end of the device. The discharge aperture may be completely surrounded and enclosed by the fluid conduit so that the NO-containing gas flow exiting the discharge aperture enters the fluid conduit.

The cooling member may include an output nozzle at the second end of the cooling member. The output nozzle may be in fluid communication with the fluid conduit so that the NO-containing gas flow can be discharged through the output nozzle. The cooling member may include a coolant input port and a coolant output port, the input port and the output port being in fluid communication with the cooling chamber.

A cooling fluid may be injected into the cooling chamber via the input port and discharged via the output port so that the circulating cooling fluid within the cooling chamber can cool the NO-containing gas flow. The coolant input port, the coolant output port, and the output nozzle may be removably couplable to the cooling member. Each of the input port, the output port and the output nozzle can include a plurality of threads for engaging a plurality of threads formed in the cooling member.

In some embodiments, the cooling apparatus includes a thermoelectric cooling (“TEC”) module. In other embodiments, the cooling apparatus includes a plurality of thermoelectric cooling (“TEC”) modules for surrounding the NO-containing gas flow exiting the second end of the cooling member. Each of the thermoelectric cooling (“TEC”) modules can include a heat sink and a cooling fan.

A method is disclosed for treating a biologic object. The method can include the steps of: forming an NO-containing gas flow in a device to treat a biologic object; discharging the NO-containing gas flow from a nozzle of the device; passing the NO-containing gas flow from the nozzle to a fluid conduit of a cooling member; injecting a fluid coolant into a cooling chamber in the cooling member to reduce a temperature of the NO-containing gas, the cooling chamber being separate and distinct from the fluid conduit so that the fluid coolant does not mix with the NO-containing gas; and passing the NO-containing gas from a nozzle of the cooling member through a cooling apparatus so that the temperature of the NO-containing gas is further reduced.

The method may comprise the step of removably coupling the cooling member to the device. In some embodiments, the method can further include removably coupling a coolant input port and a coolant output port to the cooling member, where the coolant input port receives the injected fluid coolant, and the coolant output port removes the injected fluid coolant. In other embodiments, the cooling apparatus includes a plurality of thermoelectric cooling (“TEC”) modules for surrounding the NO-containing gas.

An apparatus is disclosed for treating a biologic object. The apparatus may comprise a device for forming an NO-containing gas flow to treat a biologic object. The device may include a discharge aperture for releasing the NO-containing gas flow from the device. A cooling member may encapsulate the device. A cooling chamber may be located between the discharge aperture and an end of the cooling member to release the NO-containing gas flow. The NO-containing gas flow may travel from the discharge aperture through the cooling chamber before being dispensed from a distal end of the apparatus to treat the biologic object. The cooling member may include an upper shell and a lower shell, and a plurality of openings in at least one of the upper shell and the lower shell, the plurality of openings positioned for allowing air to surround the discharge aperture. The cooling chamber and the plurality of openings may be arranged such that the NO-containing gas flow draws air through the openings to engage the NO-containing gas flow. The cooling member comprises an inner channel disposed between the discharge aperture and a distal end of the cooling member, the cooling member configured to direct the NO-containing gas flow toward the distal end of the cooling member.

### BRIEF DESCRIPTION OF THE DRAWINGS

By way of example, specific embodiments of the disclosed device will now be described, with reference to the accompanying drawings, in which:

FIG. 1 illustrates a cross-sectional view of a prior art device for providing treatment of a biological object with mixed gases containing nitrogen oxide;

FIGS. 2A-2C are isometric, end, and cross-section views, respectively, of an exemplary device for providing treatment of a biological object with mixed gases containing nitric oxide;

FIGS. 3A and 3B are cross-section, and exploded views, respectively, of an exemplary cooling member of the device of FIGS. 2A-2C;

FIGS. 4A-4C are isometric, end, and exploded views, respectively, of an exemplary cooling apparatus of the device of FIGS. 2A-2C;

FIGS. 5A and 5B are transparent side and exploded views, respectively, of an alternate arrangement for coupling a cooling member to the device of FIGS. 2A-2C;

FIGS. 6A and 6B are transparent side and exploded views, respectively, of an alternate arrangement for a cooling member and for coupling a cooling member to the device of FIGS. 2A-2C;

FIGS. 7A and 7B are side, and cross-section views, respectively, of an exemplary device for providing treatment of a biological object with mixed gases containing nitric oxide; and

FIGS. 8A and 8B are transparent side and exploded views, respectively, of an alternate arrangement for a cooling member and for coupling a cooling member to the device of FIGS. 2A-2C.

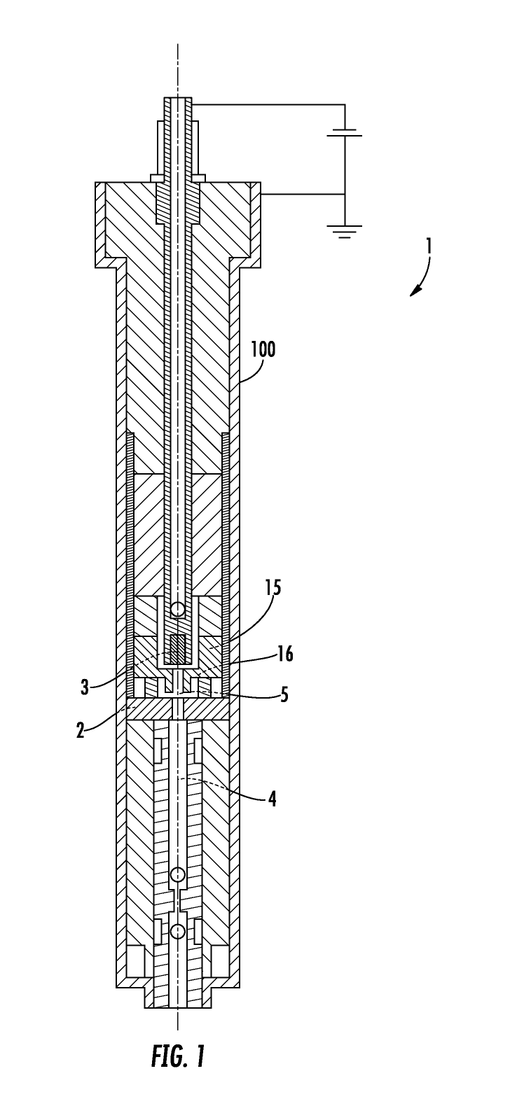

### DETAILED DESCRIPTION

A device and method in accordance with the present disclosure will now be described more fully hereinafter with reference to the accompanying drawings, in which preferred embodiments of the device and method are shown. The disclosed device and method, however, may be embodied in many different forms and should not be construed as being limited to the embodiments set forth herein. Rather, these embodiments are provided so that this disclosure will be thorough and complete, and will fully convey the scope of the device and method to those skilled in the art. In the drawings, like numbers refer to like elements throughout.

The present disclosure describes an improved device and method for providing treatment of a biological object with mixed gases containing nitric oxide (NO-containing gas). More specifically, the present disclosure describes an improved device and method that utilizes, in one exemplary non-limiting embodiment, a device and method as disclosed in U.S. Pat. No. 7,498,000. It will be appreciated, however, that although embodiments are described using the device and method disclosed in U.S. Pat. No. 7,498,000, that the presently disclosed devices and methods can be implemented in other devices that generate NO in plasma form.

The improved device and method includes a plasma cooling mechanism that may be coupled to the distal end of a device that generates NO-containing plasma. As such, the improved device modifies a discharged plasma plume to allow for a lower temperature output and higher efficiency conversion of atmospheric air thereby producing high concentrations of NO for human and animal medical applications.

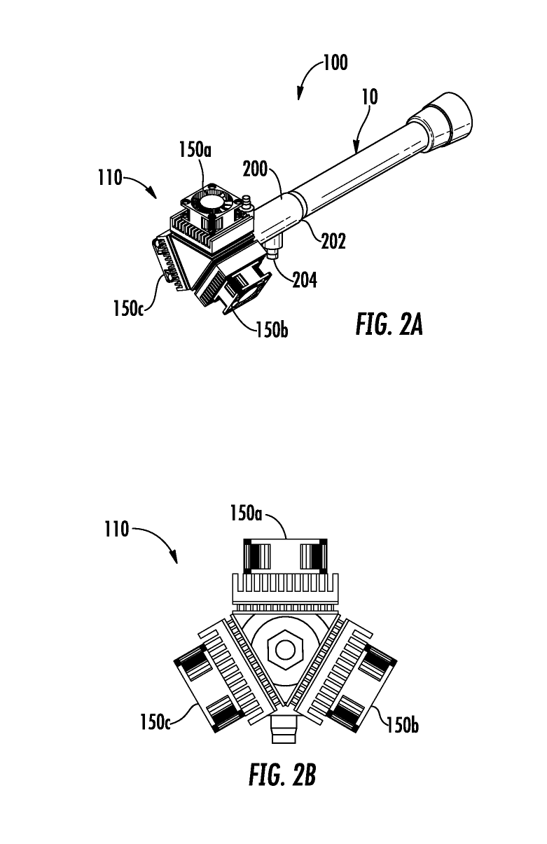

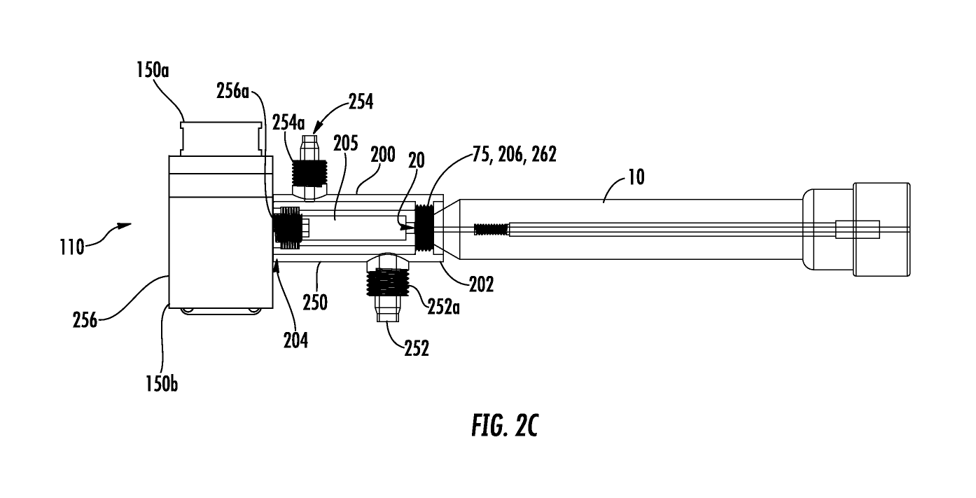

Referring to FIGS. 2A-4C, the device 100 incorporates an anode shell assembly 10 that may include at least a portion of an anode 2 and cathode 3 arrangement, for example, similar to, or the same as that disclosed in U.S. Pat. No. 7,498,000. The anode and cathode arrangement may generate a high voltage sustaining discharge arc between electrodes. However, to mitigate the heat effects of the plasma on the treatment area and to allow for a more concentrated amount of NO to be produced, the improved device 100 includes a plasma cooling mechanism 110.

As illustrated, the plasma cooling mechanism 110 may include a cooling member 200 and a cooling apparatus 150. In use, the cooling member 200 may be coupled to the distal end of the anode and cathode arrangement. The cooling assembly 150 may be coupled to the distal end of the cooling member 200.

The cooling member 200 may include a first end 202, a second end 204, an internal conduit 205 running from the first end to the second end for passing the plasma plume or NO containing plasma/gas from the first end to the second end, and a cooling chamber 250 located between the first and second ends 202, 204 and surrounding the fluid conduit 205.

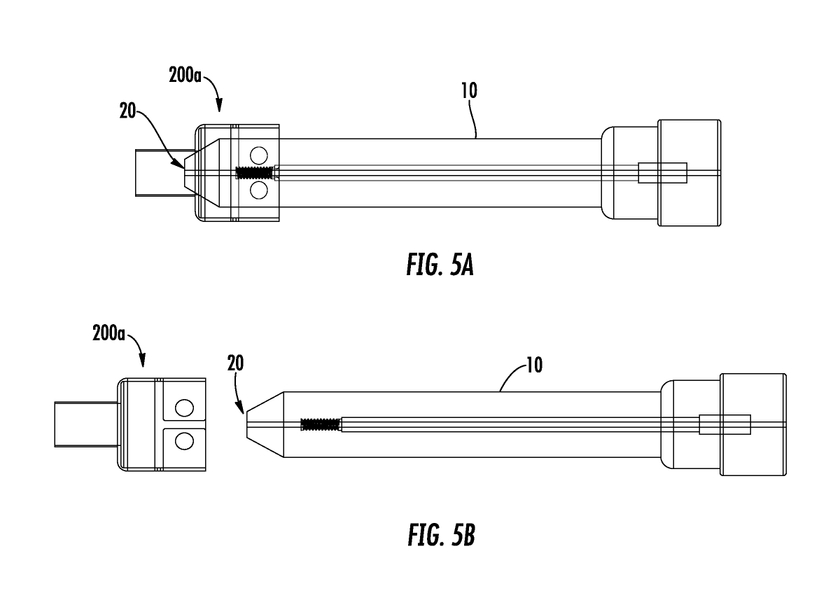

The first end 202 of the cooling member 200 may be coupled to the anode shell assembly 10 so that the internal conduit 205 is in fluid communication with the discharge aperture 20 of the anode shell assembly 10. In the illustrated embodiment, the first end 202 may include a plurality of internal threads 206 for engaging a plurality of external threads 75 formed on the distal end of the anode shell assembly 10. By coupling the cooling member 200 to the anode shell assembly 10 in this manner, the discharge aperture 20 may be completely surrounded and enclosed by the internal conduit 205 formed in the cooling member 200 so that the discharge aperture 20 and hence the discharge plume 50 exiting the discharge aperture 20 may be enclosed within, and directed through, the conduit 205. While the cooling member 200 is shown and described as including a plurality of threads for engaging threads formed on the anode shell assembly 10, it is contemplated that the anode shell assembly 10 and the cooling member 200 may be coupled by any other arrangement or method now or hereafter known including, but not limited to, welding, compression fittings, fasteners, or bayonet lock (see, e.g., FIGS. 5A, 5B).

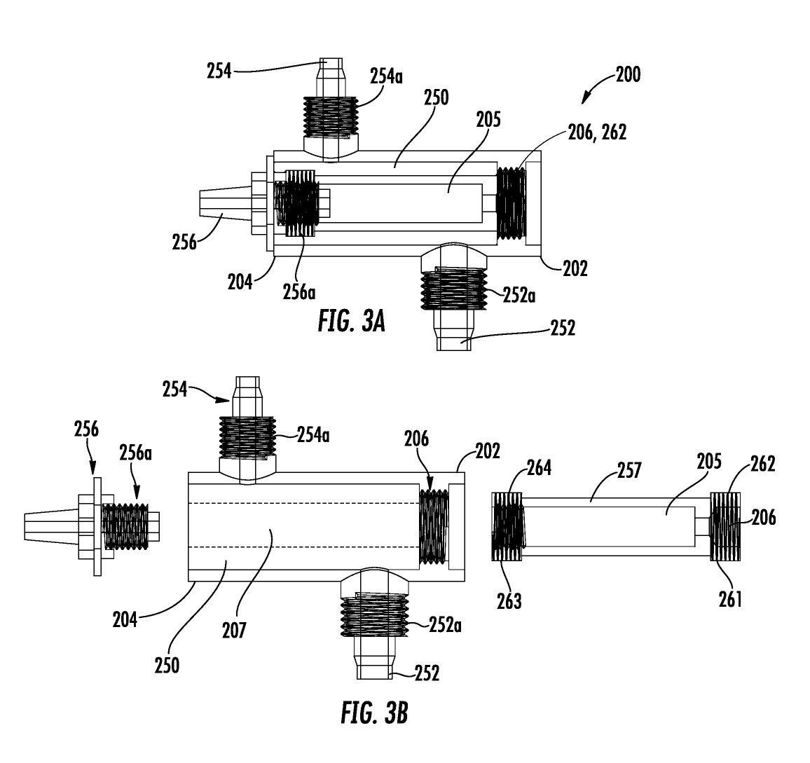

As best shown in FIGS. 3A and 3B, the cooling member 200 may further include a coolant input port 252, a coolant output port 254, a plasma output nozzle 256 and a conduit insert 257. The nozzle 256 may be in fluid communication with the internal fluid conduit 205 via a connection with the conduit insert 257. That is, the conduit insert 257 may include a first end 261 and a second end 263. The conduit insert 257 has a size and shape adapted for insertion into a borehole 207 formed in the cooling member 200. The first end 261 of the conduit insert 257 may include external threads 262 for engaging internal threads 206 formed on the first end 202 of the cooling member 200. In addition, the first end 261 of the conduit insert 257 may include the internal threads 206 for engaging the external threads 75 formed on the distal end of the anode shell assembly 10 (FIG. 2C). The second end 263 of the conduit insert 257 may include internal threads 264 for engaging corresponding threads of the plasma output nozzle 256, as will be described in greater detail below. Although the cooling member 200 and the conduit insert 257 have been described as separate pieces, it is contemplated that the cooling member 200 could be formed as a single piece.

As previously mentioned, the cooling member 200 may also include a coolant input port 252, a coolant output port 254, and a plasma output nozzle 256. The input port 252 and the output port 254 may be in fluid communication with a cooling chamber 250. In use, the discharge plume 50, exiting the discharge aperture 20 of the anode shell assembly 10, may enter the fluid conduit 205 at the first end 202 of the conduit insert 257 and may exit the cooling member 200 via the plasma output nozzle 256 at the second end 204 thereof. At the same time, a cooling fluid, such as, for example, water, may be circulated into, through and out of the cooling chamber 250 surrounding the conduit insert 257 and the internal fluid conduit 205 by injecting the cooling fluid into the input port 252 and removing it from the output port 254. The cooling chamber 250 is separated from the fluid conduct 205 by the wall 259 of the conduit insert 257 so that the cooling fluid injected into the cooling chamber 250 does not mix with the NO-containing gas traveling in the fluid conduit 205. Nevertheless, by cooling the cooling member, and particularly, the conduit insert 257, the cooling fluid may transfer heat generated by the plasma plume 50 to the cooling fluid passed through the cooling unit 200, thus facilitate cooling of the plasma plume 50. The coolant circulated through the cooling chamber 250 may originate from coolant used to cool the anode and cathode arrangement 10 or from an external source. It will be appreciated, however, that such a cooling arrangement is not critical, and the coolant may be supplied from the nozzle or from any other appropriate source.

The coolant input port 252, coolant output port 254, and plasma output nozzle 256 may be coupled to the cooling member 200 by any means now or hereafter known. For example, as illustrated, each of the coolant input port 252 and coolant output port 254 may include threads 252a, 254a, for engaging corresponding threads formed in the cooling member 200. Similarly, the plasma output nozzle 256 may include threads 256a for engaging threads 264 formed on the second end 263 of the conduit insert 257. It will be appreciated that although the connections described herein refer to threaded engagement, that the disclosure is no so limited, and another other type of appropriate connection scheme could be used. Alternatively, the coolant inlet and outlet ports 252, 254, could be included as integral parts of the cooling member 200.

Referring to FIGS. 2A-C and 4A-C, the plasma cooling mechanism 110 may also include one or more cooling apparatuses 150 for surrounding the exiting plasma plume 50. As illustrated, the device 100 may include first, second and third cooling apparatuses 150a, 150b, 150c for surrounding the exiting plasma plume 50 however, it should be understood that more or less cooling apparatuses 150 may be used. The first, second and third cooling apparatuses 150a, 150b, 150c may be coupled to one another and to the device 100 by any means now known or hereafter developed, for example, a frame (not shown) may be used to hold the first, second and third cooling apparatuses 150a, 150b, 150c. Thereafter, the frame may be coupled to the device 100 by any means now or hereafter developed including, for example, threads, fasteners, press-fit, adhesive, etc.

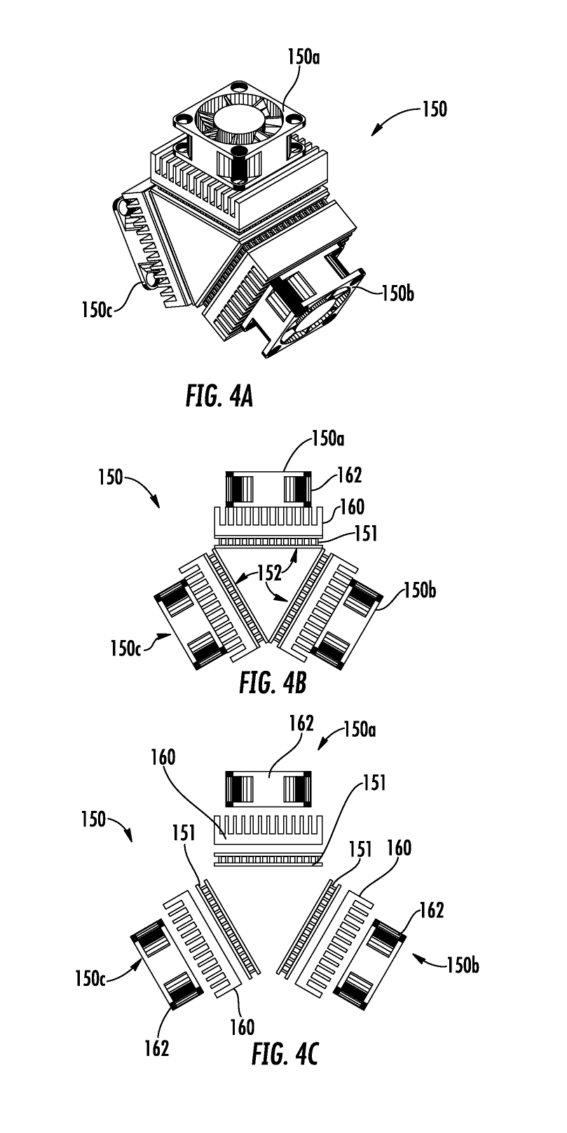

As shown in FIGS. 4A-C, the cooling apparatuses 150a-c may each be in the form of a thermoelectric cooling (“TEC”) module 151, commonly referred to as a Peltier Device. In use, the TEC modules 151 can be coupled to the second end 204 of the cooling member 200 (FIGS. 2A-C) so that the plasma plume 50 (FIG. 3) exiting the plasma output nozzle 256 is surrounded by the cooling side 152 of the TEC modules 151. That is, each of the cooling sides 152 of each of the TEC Module 151 face inward toward the plasma plume 50 so that collectively the cooling sides 152 of the TEC Modules 151 surround the exiting plasma plume 50. Each of the TEC modules 151 may also be fitted with a heat sink 160 and a cooling fan 162 to further assist in the removal of the heat from the plasma plume 50 and to cool the surrounding atmospheric air. The TEC modules 151, heat sinks 160 and cooling fans 162 may be coupled to one another by any means now known or hereafter developed including, for example, via a thermal grease, an adhesive, brazing, mounting wire, etc. In one embodiment, the heat sink 160 may be mounted to the “hot” side of the TEC module 151 using thermal grease as a contact medium between the heat sink 160 and TEC module 151. The cooling fans 162 may be mounted against the fin side of the heat sink 160 so that the cooling fans 162 force air around the fins of the heat sink. The cooling fans 162 may be coupled to the heat sinks 160 via a mounting wire. The lower temperature air reduces dissipation due to the compression factor of gas at lowered temperatures. Power sources may be applied to the TEC modules 151 with variable input voltages and current so as to efficiently control the heat dissipation away from the plasma output nozzle 256 and the plasma plume 50.

Referring to FIGS. 5A and 5B, an alternative embodiment for connecting the anode shell assembly 10 with the cooling member 200 is shown. In this embodiment, an adapter 200a is provided. In use, the adapter 200a may be used to surround the plasma plume as a form of a heat-sink to allow the mass of the balance of the nozzle body to draw heat into it as a heat mass. The adapter 200a can be coupled to the anode shell assembly 10 by any means now known or hereafter developed, for example, the adapter 200a can include a plurality of threads for engaging threads formed on the anode shell assembly 10. In some embodiments, the adapter 200a can be used independent of (i.e., without) the cooling member 200.

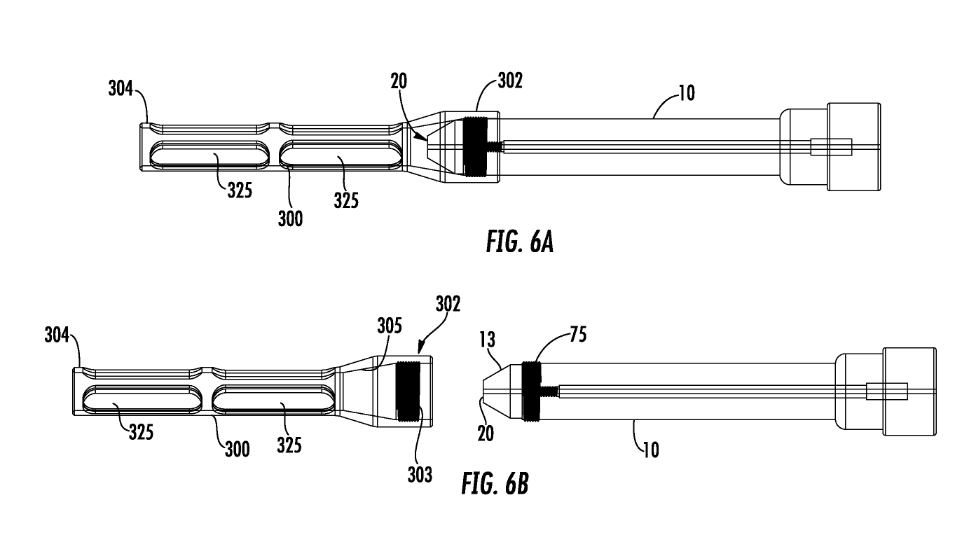

Referring now to FIGS. 6A and 6B, an alternate embodiment of the cooling member 300 is shown. Cooling member 300 may be substantially similar to cooling member 200 described above except as mentioned herein. As illustrated, cooling member 300 may include a first end 302 for coupling to the anode shell assembly 10 adjacent the discharge aperture the discharge aperture 20, and an opposite second end 304. The first end 302 includes an expanded section for receiving the portion of the anode shell assembly 10 adjacent the discharge aperture 20, and includes internal threads 303 for coupling with external threads 75 formed on the distal end of the anode shell assembly 10 adjacent the discharge aperture. The first end 302 may include an internal conical portion 305 for engaging a conical nose portion 13 of the anode shell assembly 10.

A plurality of cavities 325 may be formed through the walls of cooling member 300. These cavities 325 may be circumferential disposed about the cooling member 300 so that air may enter into the cooling member 300 to surround the plasma plume. In use, the discharge plume exiting the discharge aperture 20 of the anode shell assembly 10 may enter the cooling member 300 at the first end 302 thereof and exit the cooling member 300 at a second end 304 thereof. However, in connection with cooling member 300, air may enter into one or more cavities 325 and may surround and encase the plasma plume. In this manner, the air, having a much lower relative temperature as compared to the plasma plume 50 exiting the discharge aperture 20, may absorb the heat generated by the plasma plume 50 and thus facilitate cooling of the plasma plume 50. It will be understood that while the cooling member 300 is shown as having two cavities 325 on each side of the member 300, for a total of eight (8) cavities, it is contemplated that cooling member 300 may have more or less cavities, and that the cavities may take on different sizes and shapes. In addition, it is contemplated that the alternate embodiment of the cooling member 300 may be used alone or in combination with the TEC modules 151 shown and described above. Although the cooling member 300 is shown as being circular in shape, it is contemplated that the shape of the cooling member 300 can be conical or it can be provided in other geometric or non-geometric shapes.

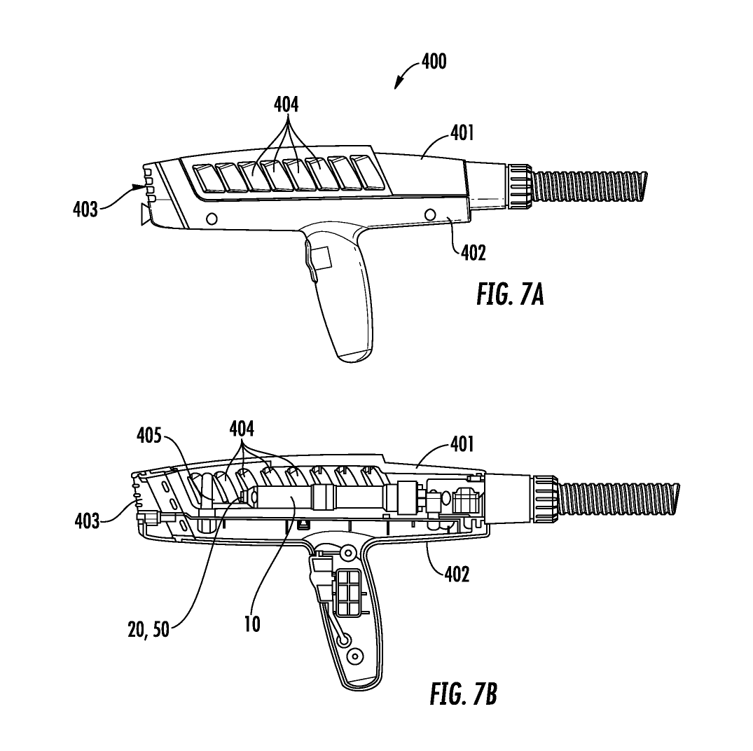

Referring to FIGS. 7A and 7B, a further embodiment of a cooling member 400 is shown. Cooling member 400 may be substantially similar to cooling member 300 above except as mentioned herein. As illustrated, cooling member 400 can include an upper shell 401 and a lower shell 402 which together enclose anode shell assembly 10. The upper shell 401 can include a plurality of openings (e.g., vents) 404 positioned adjacent to the anode shell assembly 10. Although not shown, it will be appreciated that such openings may also, or alternatively, be included in the lower shell. During operation, ambient air from outside the cooling member 400 may flow through one or more of the openings 404 and may surround or encase the plasma plume 50 and/or the NO gas emanating from the discharge aperture 20. In some embodiments, the flow of the plasma plume 50 and/or the NO gas emanating from the discharge aperture 20 may draw ambient air from outside the cooling member 400 through the openings 404 to surround or encase the plasma plume and/or the NO gas. Because the air arriving through the openings 404 may have a much lower relative temperature as compared to the plasma plume 50 exiting the discharge aperture 20, the arriving air can absorb the heat generated by the plasma plume 50 to thereby cool the plasma plume.

It will be understood that the cooling member 400 may have a fewer or greater number of openings 404 than illustrated, and that the openings may take on different sizes and shapes as compared to those shown in the illustrated embodiment. The openings 404 may also be positioned at various angles to optimize the interaction of the ambient air and the plasma plume 50 exiting the discharge aperture 20.

In some embodiments, the cooling member 400 can include an inner channel 405 disposed between the discharge aperture 20 and a distal end 403 of the cooling member 400. The inner channel 405 may direct the NO gas toward the distal end 403 of cooling member 400. In one embodiment, the inner channel 405 is created by the upper shell 401 and the lower shell 402. In addition, it is contemplated that the embodiment of cooling member 400 may be used alone or in combination with TEC modules 151 shown and described above. Further, although the description details an upper and lower shell, it is contemplated that cooling member 400 could be constructed of a single component.

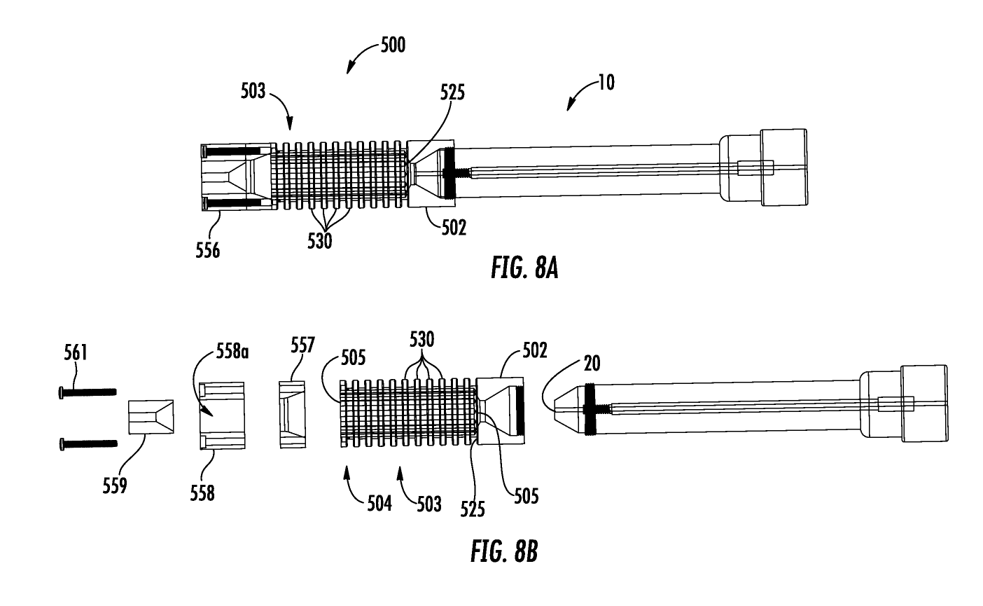

Referring to FIGS. 8A and 8B, a further embodiment of the cooling member 500 is shown. Cooling member 500 may be substantially similar to cooling members 200 and 300 described above except as mentioned herein. As illustrated, cooling member 500 may have a first end 502 for coupling to the anode shell assembly 10 adjacent the discharge aperture 20. A body portion 503 of the cooling member 500 may include a plurality of cavities 525 and a plurality of radial fins 530 for surrounding and encasing the plasma plume 505. In use, the discharge plume 50 exiting the discharge aperture 20 may enter the conduit 505 at the first end 502 of the cooling member 500 and exit the cooling member 500 at a second end 504 thereof, for example, via a plasma output nozzle 556. Although the cooling member 500 is illustrated as being composed of multiple individual pieces (including, e.g., plasma nozzle 556), it is contemplated that the one or more of the individual pieces could be combined such that the cooling member 500 could be a single piece.

The plurality of radial fins 530 provides for increased surface area so that air surrounding the cooling member 500 can cool the cooling member. In this manner, the outside air may draw off the heat generated by plasma plume 50 and thus facilitate cooling of the plasma plume 50. It should be understood that while the cooling member 500 is shown as being in the form of a plurality of longitudinal slots encircling the cooling member 500, it is contemplated that cooling member 500 may have more or less cavities, and that the cavities may take on different sizes and shapes. Similarly, the number, size and shape of the radial fins 530 may be different.

The plasma output nozzle 556 may be formed by one or more elements. For example, as shown, the output nozzle 556 may include an adapter 557, a bushing 558 and a nozzle insert 559. In use, the adapter 557 can be coupled to the second end 504 of the cooling member 500. The bushing 558 can be coupled to the adapter 557 and the insert nozzle 559 may be received within a borehole 558a formed in the bushing 558. Complementary openings in each piece receive and pass the plasma plume 50 therethrough. As arranged, the plasma output nozzle 556 may be easily removable and replaceable as necessary. In addition, various and interchangeable elements may be provided to enable the user to more easily adjust and control the flow rate of the plasma plume 50.

The adapter 557, bushing 558 and nozzle insert 559 may be coupled together and coupled to the cooling member 500 by any means now known or hereafter developed including, but not limited to, fasteners 561. While the multiple part plasma output nozzle 556 has been shown and described in connection with the cooling member 500 illustrated in FIGS. 8A and 8B, it is contemplated that the multiple part plasma nozzle 556 may be readily adapted and used in combination with cooling members 200 and 300 as previously described.

The devices according to the present disclosure have the effect of concentrating the arc discharge plume in a tightly confined ducted conduit which more efficiently converts atmospheric air into extremely high concentrations of NO. Furthermore, the heat dissipation provided by the jacketed cooling conduit in conjunction with the TEC module configuration surrounding the aperture lowers the temperature of the stream of NO output. This can result in application temperatures directly at the output point of approximately 25 to 52 degrees Celsius, with NO concentrations of between 500 and 5,000 parts per million (PPM) and beyond, and more desirably between 500 and 1,200 PPM.

This extremely high NO produced at such low temperatures allows for the treatment of previously untreatable areas such as the eyes, mucous membranes, etc. Furthermore, the high efficiency conversion resulting in NO concentrations of over 500 PPM allows for shorter treatment times and higher efficacy in all types of applications of this therapeutic modality.

It should be understood, that while the plasma cooling mechanisms of the present disclosure has been described as including one or more cooling apparatuses 150 and a cooling member 200, 300, 400, 500, it is contemplated that the improved device 100 may be configured with only a cooling member 200, 300, 400, 500 and no cooling apparatus 150, or vice-versa (with a cooling apparatus 150 and no cooling member 200, 300, 400, 500). In addition, while the cooling apparatuses 150 are shown in combination with cooling member 200, it is contemplated that the cooling member 200 is interchangeable with cooling members 300, 400 and 500 such that the cooling apparatuses 150 may be used in combination with cooling members 300, 400 and 500. Alternatively, the cooling apparatus 150 could, in some embodiments, be used to cool the plasma plume 50 without the cooling member 200.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. An apparatus for treating a biologic object, the apparatus comprising:
a device for forming NO-containing gas flow to treat the biologic object, the device including a distal end having a discharge aperture for releasing NO-containing gas flow; and
a cooling member having a first end, a second end, a fluid conduit extending from the first end to the second end, and a cooling chamber located between the first and second ends and surrounding the fluid conduit, the first end of the cooling member being coupled to the distal end of the device.

2. The apparatus of claim 1, further comprising a cooling apparatus coupled to the second end of the cooling member; wherein the fluid conduit is in fluid communication with the discharge aperture so that the NO-containing gas flow travels from the discharge aperture through the fluid conduit and past the cooling apparatus before treating the biologic object.

3. The apparatus of claim 1, wherein the first end of the cooling member is removably attached to the distal end of the device.

4. The apparatus of claim 3, wherein the first end of the cooling member includes a plurality of threads for engaging a plurality of threads formed on the distal end of the device.

5. The apparatus of claim 1, wherein the discharge aperture is completely surrounded and enclosed by the fluid conduit so that the NO-containing gas flow exiting the discharge aperture enters the fluid conduit.

6. The apparatus of claim 5, wherein the cooling member further comprises an output nozzle at the second end of the cooling member, the output nozzle being in fluid communication with the fluid conduit so that the NO-containing gas flow can be discharged through the output nozzle.

7. The apparatus of claim 6, wherein the cooling member further comprises a coolant input port and a coolant output port, the input port and the output port being in fluid communication with the cooling chamber.

8. The apparatus of claim 7, wherein a cooling fluid is injected into the cooling chamber via the input port and discharged via the output port so that the circulating cooling fluid within the cooling chamber can cool the NO-containing gas flow.

9. The apparatus of claim 8, wherein the coolant input port, the coolant output port, and the output nozzle are removably coupled to the cooling member.

10. The apparatus of claim 9, wherein each of the input port, the output port and the output nozzle include a plurality of threads for engaging a plurality of threads formed in the cooling member.

11. The apparatus of claim 2, wherein the cooling apparatus includes a thermoelectric cooling (“TEC”) module.

12. The apparatus of claim 11, wherein the cooling apparatus includes a plurality of thermoelectric cooling (“TEC”) modules for surrounding the NO-containing gas flow exiting the second end of the cooling member.

13. The apparatus of claim 12, wherein each of the thermoelectric cooling (“TEC”) modules include a heat sink and a cooling fan.

14. A method for treating a biologic object, the method comprising the following steps:
forming an NO-containing gas flow in a device to treat a biologic object;
discharging the NO-containing gas flow from a nozzle of the device;
passing the NO-containing gas flow from the nozzle to a fluid conduit of a cooling member; and
injecting a fluid coolant into a cooling chamber in the cooling member to reduce a temperature of the NO-containing gas, the cooling chamber being separate and distinct from the fluid conduit so that the fluid coolant does not mix with the NO-containing gas.

15. The method of claim 14, further comprising passing the NO-containing gas from a nozzle of the cooling member through a cooling apparatus so that the temperature of the NO-containing gas is further reduced.

16. The method of claim 14, further comprising removably coupling the cooling member to the device.

17. The method of claim 14, further comprising removably coupling a coolant input port and a coolant output port to the cooling member, the coolant input port receiving the injected fluid coolant, the coolant output port removing the injected fluid coolant.

18. The method of claim 15, wherein the cooling apparatus includes a plurality of thermoelectric cooling (“TEC”) modules for surrounding the NO-containing gas.

19. An apparatus for treating a biologic object, the apparatus comprising:
a device for forming an NO-containing gas flow to treat a biologic object, the device including a discharge aperture for releasing the NO-containing gas flow from the device;
a cooling member encapsulating the device; and
a cooling chamber located between the discharge aperture and an end of the cooling member that releases the NO-containing gas flow;
wherein the NO-containing gas flow travels from the discharge aperture through the cooling chamber before being dispensed from a distal end of the apparatus to treat the biologic object.

20. The apparatus of claim 19, wherein the cooling member includes an upper shell and a lower shell, and a plurality of openings in at least one of the upper shell and the lower shell, the plurality of openings positioned for allowing air to surround the discharge aperture.

21. The apparatus of claim 20, wherein the cooling chamber and the plurality of openings are arranged such that the NO-containing gas flow draws air through the openings to engage the NO-containing gas flow.

22. The apparatus of claim 21, wherein the cooling member comprises an inner channel disposed between the discharge aperture and a distal end of the cooling member, the cooling member configured to direct the NO-containing gas flow toward the distal end of the cooling member.
